(19) United States
(12) Patent Application Publication
(10) Pub. No.: US 2025/0357474 A1
(43) Pub. Date: Nov. 20, 2025

(54) SILICON NANOPARTICLE ELECTRODE COMPOSITIONS AND METHODS OF MAKING THE SAME

(71) Applicant: Alliance for Sustainable Energy, LLC, Golden, CO (US)

(72) Inventors: Nathan Richard NEALE, Denver, CO (US); Gerard Zachary CARROLL, Littleton, CO (US); Trevor Russell MARTIN, Boulder, CO (US)

(21) Appl. No.: 19/208,334

(22) Filed: May 14, 2025

Related U.S. Application Data
(60) Provisional application No. 63/647,356, filed on May 14, 2024.

(51) Int. Cl. H01M 4/38; H01M 4/02; H01M 4/04; H01M 4/134; H01M 4/62; H01M 4/66

(52) U.S. Cl. CPC H01M 4/386; H01M 4/0404; H01M 4/134; H01M 4/622; H01M 4/625; H01M 4/663; H01M 2004/021

(57) ABSTRACT

The present disclosure relates to a composition that includes a plurality of silicon nanoparticles and a binder, where the composition has a porosity between 10 vol % and 90 vol %. In some embodiments of the present disclosure, the plurality of silicon nanoparticles may have an average diameter between 1 nm and 50 nm. In some embodiments of the present disclosure, at least a portion of the plurality of silicon nanoparticles may be agglomerated to form a plurality of secondary particles. In some embodiments of the present disclosure, the plurality of secondary particles may have an average diameter between >1 nm and 500 μm.

### CROSS-REFERENCE TO RELATED APPLICATIONS

This application claims priority from U.S. Provisional Patent Application No. 63/647,356 filed on May 14, 2024 and its associated appendix, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### BACKGROUND

Among other things silicon nanoparticle-based (Si NP-based) anodes suffer from low inherent porosity (approx. 15-20%) due to the nanoscopic size (approx. 10 nm diameter) of the Si NPs that densely pack upon slurry drying into films. This property limits the ionic conductivity at higher areal loading anodes. Thus, there remains a need for methods capable of manufacturing Si NP-based anodes having, among other things, increased porosities.

### SUMMARY

An aspect of the present disclosure is a composition that includes a plurality of silicon nanoparticles and a binder, where the composition has a porosity between 10 vol % and 90 vol %. In some embodiments of the present disclosure, the plurality of silicon nanoparticles may have an average diameter between 1 nm and 50 nm. In some embodiments of the present disclosure, at least a portion of the plurality of silicon nanoparticles may be agglomerated to form a plurality of secondary particles. In some embodiments of the present disclosure, the plurality of secondary particles may have an average diameter between 1 nm and 500 μm.

In some embodiments of the present disclosure, the binder may include a polymer. In some embodiments of the present disclosure, the polymer may include at least one of a polyimide, polyimide, a polyamide-imide, a polyether ether ketone, polytetrafluoroethylene, a polyetherimide, polybenzimidazole, polyphthalamide, or a combination thereof. In some embodiments of the present disclosure, the silicon nanoparticles may be present at a concentration between 1 wt % and 99 wt %. In some embodiments of the present disclosure, the binder may be present at a concentration between 1 wt % and 99 wt %.

In some embodiments of the present disclosure, the composition may further include a conductive additive. In some embodiments of the present disclosure, the conductive additive may include at least one of carbon black, a carbon nanotube, or a combination thereof. In some embodiments of the present disclosure, the carbon nanotubes may have an aspect ratio between 1:1 and 1000:1.

In some embodiments of the present disclosure, the composition may further include a plurality of pores having a pore size distribution between 1 nm and 10 μm. In some embodiments of the present disclosure, the plurality of pores may be characterized by at least one of column-like voids, voids between secondary particles, a network of non-uniform pores, or a combination thereof. In some embodiments of the present disclosure, the composition may further include a mesoporosity between greater than 0 vol % and 60 vol %.

An aspect of the present disclosure is an electrode that includes any one of the compositions positioned, as described herein, on a current collector. In some embodiments of the present disclosure, an electrode may have a cycle life between 300 cycles and 1000 cycles before a capacity of 80% is achieved. In some embodiments of the present disclosure, the composition may be present on the current collector in the form of a layer having a thickness between 5 μm and 50 μm or between 10 μm and 25 μm.

An aspect of the present disclosure is a method of making a composition, where the method includes the use of a pore-directing agent (PDA) to produce at least a portion of the porosity present in the composition. In some embodiments of the present disclosure, the PDA may include a polymer. In some embodiments of the present disclosure, the method may include one or more of following steps, any two or more of which may be combined in a single step: a first combining of Si NPs and a solvent to make a first suspension; a second combining of the first suspension with a PDA; a third combining of the second suspension with a binder to form a third suspension; depositing of the third suspension onto a current collector to make a first intermediate electrode; drying the first electrode to make a second intermediate electrode; and removing of at least a portion of the PDA to create an electrode having the composition positioned on the electrode.

### BRIEF DESCRIPTION OF DRAWINGS

Some embodiments are illustrated in referenced figures of the drawings. It is intended that the embodiments and figures disclosed herein are to be considered illustrative rather than limiting.

FIG. 1 illustrates a method for making electrodes, according to some embodiments of the present disclosure.

FIG. 2 illustrates intermediate compositions that may be produced during the method illustrated in FIG. 1, according to some embodiments of the present disclosure.

FIG. 3 illustrates aspects of the present disclosure, according to some embodiments of the present disclosure. (Left) top-down SEM images of composite electrodes that were not fabricated with a PDA. (Middle) Cross sectional and Top-down SEM images that were fabricated with a pore directing agent (#1) (poly acrylic acid) that agglomerates nanoparticles into secondary particles. (Right) Top-down SEM images of an electrode fabricated with a pore directing agent (#2) (polycarbonate) that agglomerates nanoparticles into secondary particles.

FIG. 4 illustrates top-down SEM images of electrodes with varied pore-directing agent (#2), polyacrylic acid, to silicon nanoparticles mass ratios, according to some embodiments of the present disclosure.

FIGS. 5A-5D illustrate a comparison of electrochemical performance data between structured and unstructured electrodes, according to some embodiments of the present disclosure. The dark trace (circles) are data from an electrode that did not contain any PDA and the light trace (triangles) is an electrode made with a PDA. FIG. 5A illustrates lifetimes of prelithiated full cell electrodes where the anode active material is silicon nanoparticles, and the cathode is NMC 811.

FIG. 5B illustrates Coulombic efficiency data of cycling for the same electrodes displayed in FIG. 5A. FIG. 5C illustrates area specific impedance data for the batteries displayed in FIG. 5A. FIG. 5D illustrates rate capability data for structured and unstructured electrodes.

FIG. 6 illustrates cross sectional and top-down SEM images of electrodes that were fabricated with a PDA that does not agglomerate particles, according to some embodiments of the present disclosure. Here the PDA increases the dispersion of the primary particles to make a monolithic electrode structure.

FIGS. 7A-7C illustrate aspects of the present disclosure, according to some embodiments of the present disclosure. FIG. 7A illustrates Nyquist plots for symmetric cells (Si∥Si) with 1.2M tetrabutylammonium hexafluorophosphate in acetonitrile. The traces moving from left to right are silicon electrodes made with different PDA: silicon ratios (increasing polyethylene glycol PDA from left to right) where the PDA improves the nanoparticle suspension instead of causing aggregation. The marked trace (*) is a control electrode made with large silicon particles (25× larger than the size of the particles in other traces) and the marked trace (**) is a symmetric graphite electrode. FIG. 7B illustrates a plot of the tortuosity factor (squares) and MacMullin number (diamonds) versus PDA (i.e., fugitive phase) for each electrode. FIG. 7C illustrates ideality factors for the impedance data plotted in FIG. 7A.

FIG. 8 illustrates a method of making an electrode with a PDA, according to some embodiments of the present disclosure.

FIG. 9 illustrates a top-down view of SEM images of electrodes manufactured using varied silicon and PDA concentrations, according to some embodiments of the present disclosure. The most dilute concentration is shown on the left to make sparse and large aggregates and the composition on the right is the most concentrated slurry to make densely packed small aggregates.

FIG. 10 illustrates electrochemical cycling data for a Si∥Li half cell using polyacrylic acid as a PDA, according to some embodiments of the present disclosure. The data on the top shows the mass of silicon deposited onto an electrode through blade coating a slurry onto a current collector where the error bars are the average of five different measurements. The data in the middle show the areal capacity of the as a function of the silicon mass when cycled between two different voltage windows and at two different dilithiation rates. The data at the bottom show the electrode specific capacity for the same data in the middle. Here the total mass of the electrode (silicon, conductive carbon, binder) excluding the current collector was used to calculate electrode specific capacity.

FIG. 11 illustrates electrochemical cycling data for electrodes made with PDAs (x's) and electrodes made without PDAs (circles) at different thicknesses, according to some embodiments of the present disclosure. Here the cathode was NMC811 and the electrolyte was 1.2M lithium hexafluorophosphate in 3:7 ethylene carbonate: ethylmethyl carbonate and 3 wt % fluoroethylene carbonate.

FIGS. 12A and 12B summarize PDA experiments and results reported herein, according to some embodiments of the present disclosure. Shaded rows indicated champion devices having superior final physical properties and/or performance metrics.

To facilitate understanding, identical reference numerals have been used, where possible, to designate identical elements that are common to the figures. It is contemplated that elements and features of one embodiment may be beneficially incorporated in other embodiments without further recitation.

### REFERENCE NUMERALS

100 method
103 silicon nanoparticles (Si NPs) and/or aggregates of SiNPs
105 solvent
110 first combining
115 first suspension
117 pore-directing agent (PDA)
120 second combining
125 second suspension
127 binder and/or conductive material
130 third combining
135 third suspension
137 current collector
140 depositing
145 intermediate electrode
150 drying
152 volatiles
160 removing
162 PDA or PDA deconstruction products
155 electrode
200 first composition
205 secondary particle
210 second composition
220 third composition

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

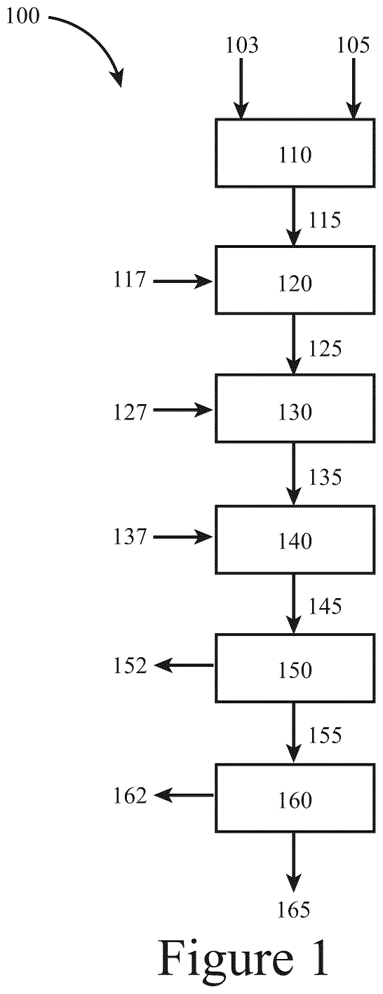

The present disclosure relates to electrodes, e.g., anodes, that contain an active material (e.g., silicon nanoparticles), an electronically conductive additive, a binder material, and/or a pore-directing agent (PDA, i.e., fugitive phase) where the electrodes are characterized by high porosities (e.g., between 4 vol % and 70 vol % empty volume), which, among other things, enable improved ion transport in lithium-ion batteries. FIG. 1 illustrates a method 100 for making such an electrode 165, according to some embodiments of the present disclosure. As illustrated, such a method 100 may include a series of combining steps resulting in a series of liquid suspensions, concluding with the depositing 140 of a final suspension (i.e., third suspension) 135 onto a current collector 137 resulting in a temporary intermediate electrode 145, which is subsequently treated in a removing 150 step to remove the PDA 152, resulting in the targeted, highly porose electrode 165. This electrode 165 may then be incorporated into a battery and/or the electrode 165 may undergo subsequent processing steps (not shown), depending on the application. Examples of PDAs include polyacrylic acid (a polyacrylate), polyethylene glycol (a polyether), polypropylene carbonate (a polycarbonate), polyvinylpyrrolidone (a polymeric lactam), polystyrene, a polyester, a poly(methyl methacrylate), poly(phtalaldehyde), a polyamide, and/or a polyurethane.

Referring to FIG. 1, a method 100 may begin with a first combining 110 of silicon nanoparticles (Si NPs) and/or aggregates of Si NPs 103 and a solvent 105, resulting in the forming of a first suspension 115 of Si NPs and/or aggregates of SiNPs suspended in the solvent. In some embodiments of the present disclosure, a solvent 105 may be an organic solvent such as N-methyl pyrrolidone, dimethyl sulfoxide, dimethylformamide, dimethyl acetamide, ethyl acetate, sulfolane, and/or water. In some embodiments of the present disclosure, Si NPs 103 may have a molecular surface functionalization which can act as a fugitive phase (i.e., a phase that can be subsequently removed). Such a molecular surface functionalization may include a variety of molecules covalently and/or non-covalently attached to the surface of the Si NPs 103 N-methyl-2-pyrrolidone (NMP), 1-hexene, 1-hexanol, 1-hexanethiol, 1-dodecene, 1-dodecanol, 1-dodecanethiol, 1-octadecene, 1-octadecanol, 1-octadecanethiol, polyethylene glycol methyl ether, polyethylene oxide vinyl ether, phenol, aniline, phenylene diamine, melamine, 1,3,5-triamino benzene, 4,4′-biphenyl diamine, 1,2,4,5-benzentetraamine, benzoic acid, benzaldehyde, styrene, 2-naphthol, 2-vinylnaphthalene, 2-naphthalenemethanol, 4-vinyl biphenyl, 4-phenyl phenol, 4-biphenyl methanol, biphenyl 4-carboxaldehyde, phenol 4-carboxaldehyde, hexaketocyclohexane, cyclohexane-1,2,4,5-tetraone, 4-terphenylol, 4-terphenyl thiol, terphenyl 4-carboxaldehyde, 4-phenylazophenol, polyacrylic acid (PAA), polyacrylonitirile, polyphenyl methylethanimine (PMI), polyethylene oxide, acrylic acid, lithium acrylate, benzene-1,4-dicarboxaldehyde, benzene-1,3-dicarboxaldehyde, benzene-1,3,5-tricarboxaldehyde, 4-formylbenzoic acid, 4-(4-formylphenoxy)benzaldehyde, tris(4-formylphenyl)amine, 2,5-thiophenedicarboxaldehyde, 2,6-pyridinedicarboxaldehyde, thieno[3,2-b]thiophene-2,5-dicarboxaldehyde, and/or 2,5-dimethoxybenzene-1,4-dicarboxaldehyde. In some instances, an electronically or ionically conductive additive (not shown), e.g., a carbonaceous material such as low-density carbon, conductive carbon, carbon nanotubes, and/or graphene, may be included in a first combining 110 to produce a first suspension 115 of the carbonaceous material and the Si NPs and/or aggregates of Si NPs suspended in the solvent.

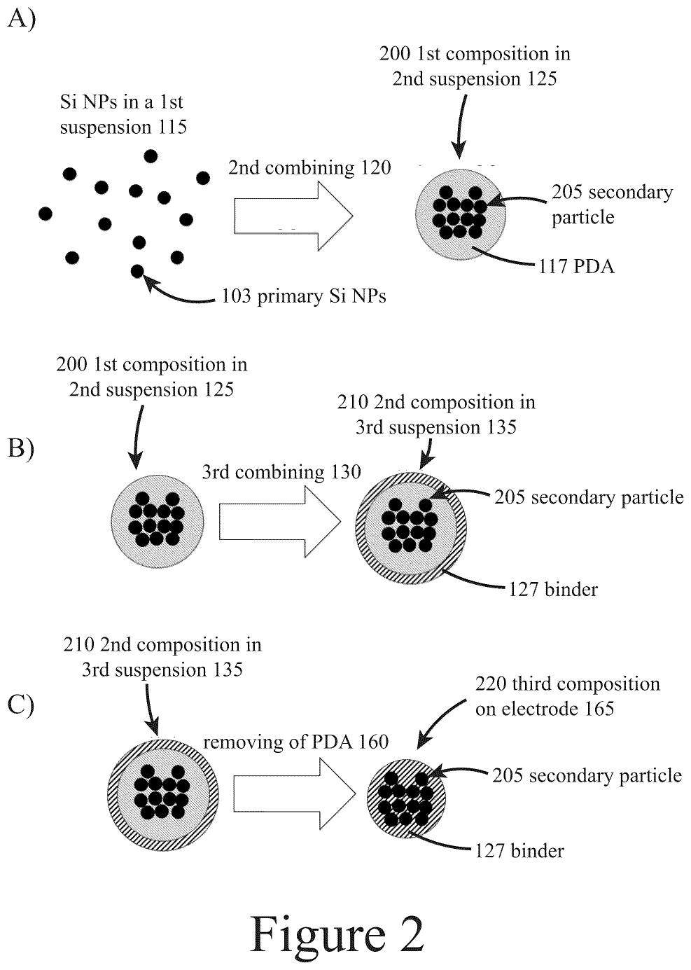

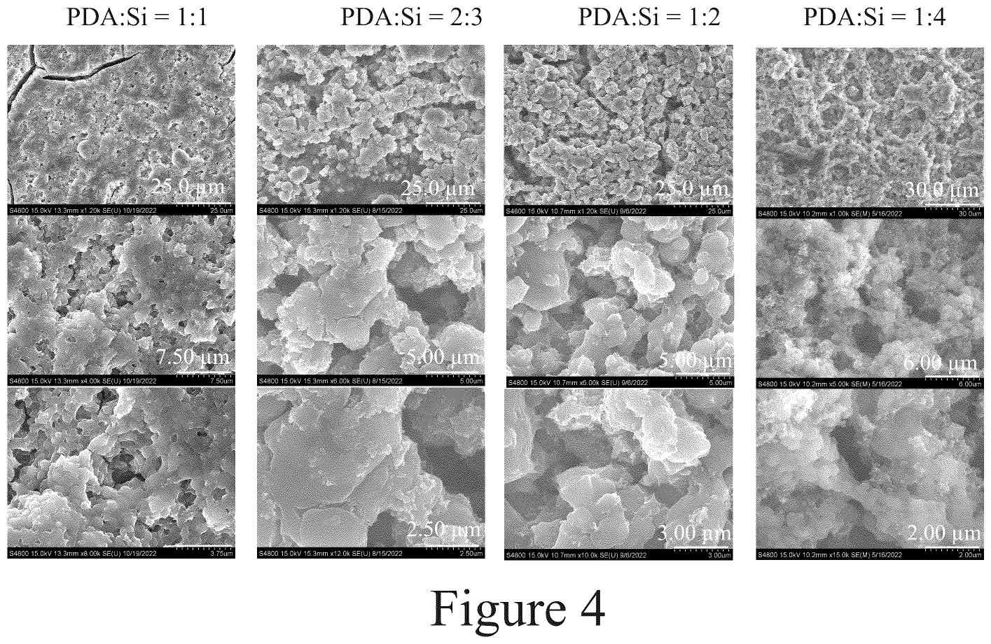

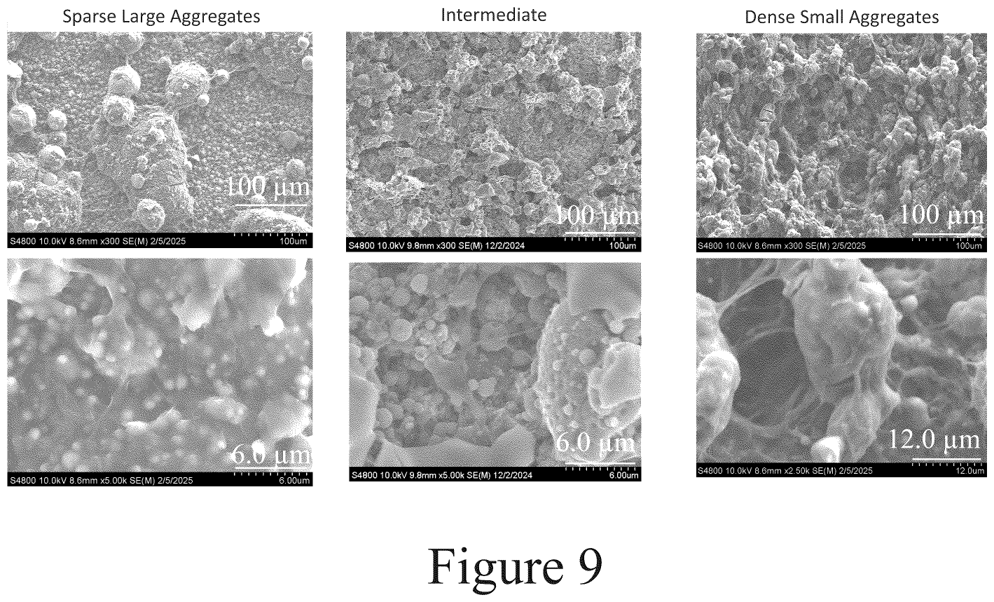

After a first suspension 115 containing Si NPs 103 is created, a PDA 117 may be added to the first suspension 110 in second combining 120 step, creating a second suspension 125. Among other things, a PDA 117 may induce agglomeration of the Si NPs 103 suspended in the first suspension 115. This agglomeration may result from the interactions between the surfaces of the Si NPs 103 and the PDA 117. In some cases, the chemical and/or physical properties of a PDA 117 may be such that the Si NPs and/or aggregates of Si NPs 103 and the PDA 117 are completely soluble or form a suspension (completely dispersed) in the liquid phase solution such that no aggregation occurs upon addition of the PDA. In this example, the Si NPs 103 may be completely dispersed in the solvent 105 to create a colloidal dispersion 110. Alternatively, the chemical and/or physical properties of a PDA 117 may be such that the Si NPs of Si NPs 103 and the PDA 117 are not completely soluble or do not form a suspension in the liquid phase solution and create an aggregation of the Si NPs thereby creating agglomerates of Si NPs and/or larger aggregates of starting aggregates of Si NPs, i.e., secondary particles 205 (see FIG. 2), in the second combining 120. These secondary particles 205 of starting Si NPs and/or starting aggregates of Si NPs 103 may then act as scaffolds onto which additional aggregation and/or agglomeration can occur. As a result, as shown herein, the size of these secondary particles 205 may be controlled by the ratio of the Si NPs (see FIG. 4), the concentration of the Si NPs 103 and the PDA 177 (see FIG. 9), and/or starting Si NP aggregates 103 to the PDA 117, such that secondary particles 205 may have an average diameter between 5 nm and 10 micrometers. In some embodiments of the present disclosure, a first combining 110 step and a second combining 120 step may be combined into a single step, or at least partially combined; e.g., PDA may be added to a first suspension before all of the Si NPs have been added to the solvent. In this example, the PDA may be dissolved in the solvent 105 and the Si NPs added to the solution 120. Without wishing to be bound by theory, in this example, the Si NPs may not aggregate in the solution but instead may remain suspended and dispersed with the addition of a binder in a subsequent step inducing aggregation

Referring again to FIG. 1, a method may proceed with the addition of a binder 127 to the second suspension 125 in a third combining 130 step, to create a third suspension 135, suitable for a subsequent depositing 140 step of the third suspension 135 onto a current collector 137, resulting in the forming an intermediate electrode 145. A variety of binders 127 may be used, but generally, a binder 127 may include a high molecular weight polymer that provides some degree of adhesion between the current collector 137 the Si NPs 103 and/or the secondary particles 205 (see FIG. 2) Examples of binders include polyimide, polyamide-imide, polyether ether ketone, polytetrafluorocthylene, polyetherimide, polybenzimidazole, and polyphthalamide. In each of the three combining steps (110, 120, and 130), the components contained in the associated suspensions (115, 125, and 135) may be mixed using a variety of mixing techniques such as at mechanical stirring and/or sonication. Mixing can assist with the creation of a homogeneously dispersed colloid and/or a dispersion of Si NPs 103 and/or secondary particles 205. In some embodiments of the present disclosure, a third suspension 135 may have a viscosity between 1 mPas and 10 kPas which is controlled by the concentration of the binder, the Si NPs, and the PDA. The viscosity may also be controlled by the selection and starting viscosities of the Si NPs, the binder, and/or the PDA. Viscosity may also be controlled by the interaction between the Si NPs, the binder, and/or the PDA. Referring again to FIG. 1, a third suspension 135 may be deposited, in a depositing 140 step, onto a current collector 137 using a variety of solution processing methods. For example, in some embodiments of the present disclosure, a third suspension 135 may be deposited, onto a current collector 137 using a blade coating process at a rate between 1 mm/sec and 1 m/sec. A current collector may have a roughened surface and/or a non-roughened surface, may have engineered mechanical properties (such as high tensile strength), and/or may have an existing coating on the current collector. In some embodiments of the present disclosure, steps 120 and 130 may be combined into a single step. In some embodiments of the present disclosure, steps 110, 120, and 130 may be combined into a single step.

After depositing 140 a third suspension 135 onto a current collector 137, the resulting wet intermediate electrode 145 may be directed to a drying 150 step, where, among other things the volatiles 152, e.g., solvent, are removed from the intermediate electrode 145, resulting in the formation of a second intermediate electrode 155. In some embodiments of the present disclosure, the drying 150 of an intermediate electrode 145 may be performed under a variety of conditions. In some cases, an intermediate electrode 145 may first be placed into a reduced pressure environment where the pressure may be between 0.1 mbar and 1 bar (absolute pressures). In some embodiments of the present disclosure, an intermediate electrode 145 may be heated by ramping the temperature at a rate between 0.01° C. per minute and 100° C. per minute to a final temperature between 30° C. and 250° C. In some embodiments of the present disclosure, an intermediate electrode 145 may be placed on a preheated mantel (e.g., a heated block of metal) under atmospheric pressures where the temperature of the mantel is maintained at a range between 30° C. and 250° C. A heated intermediate electrode 145 may then be placed into a reduced pressure environment where the final pressure is held between 0.1 mbar and 1 bar. In other cases, an intermediate electrode 145 may be heated only at essentially atmospheric pressure. In this example, heat may be applied either by ramping the temperature from room temperature at a rate between 0.01° C./min to 100° C./minute or placing the electrode on a preheated mantel set to a temperature between 50° C. and 250° C. In some embodiments of the present disclosure, an intermediate electrode 155 may be dried for periods of time between 5 minutes and 24 hours. In some embodiments of the present disclosure, an intermediate electrode 145 may be dried under an inert environment (e.g, Ar, He, and/or N₂) or under an air environment.

Referring again to FIG. 1, a dried intermediate electrode 155 may be directed to a removing 160 step, where among other things, the PDA 117 may be removed resulting in the forming of the final target electrode 165. In some embodiments of the present disclosure, a fugitive phase, the PDA 117 and/or a coating on the starting Si NPs 103, may be removed by heating the intermediate electrode 155 under an atmosphere of at least one of N₂, Ar, H₂, and/or O₂, including ambient air. In some embodiments of the present disclosure, an intermediate electrode 155 may be heated to a target temperature between 100° C. and 1000° C. In some embodiments of the present disclosure, the targe temperature may be achieved using heating ramp rate between 0.01° C./min and 100° C./min. In some embodiments of the present disclosure, an intermediate electrode 155 may be maintained at a target temperature between 5 minutes and 24 hours. In other cases, a fugitive phase (i.e., a PDA 117 and/or a coating on the Si NPs 103) may be removed by rinsing an intermediate electrode 155 with an organic solvent and/or water.

In some embodiments of the present disclosure, a final electrode 165 resulting from a method 100 like that illustrated in FIG. 1 may include a layer constructed of Si NPs, a conductive additive, and a binder, with the layer positioned on a current collector 137. In some embodiments of the present disclosure, such a layer of a final electrode 165 may have a porosity (excluding the current collector 137) between 4 vol % and 70 vol % empty volume or between 15% and 50%. In some embodiments of the present disclosure, the pore size distribution of the Si NPs/additive/binder composition present on a final electrode 165 may be between 2 nm and 10 μm or between 5 nm and 1 μm. Variation of the electrode morphology at this level can provide control of the mechanical stress and strain experienced by the electrode during electrochemical cycling (charging and discharging). This morphology is also useful for controlling mass transport within the electrode as well as the total silicon interface that is accessible to the electrolyte.

Without wishing to be bound by theory, FIG. 2 illustrates further aspects of the method 100 illustrated in FIG. 1, including various compositions that may be produced during the various steps described above, according to some embodiments of the present disclosure. Panel A of FIG. 2 illustrates a first suspension 115 resulting from combining 110 Si NPs 103 with a solvent 105 and a second suspension 125 resulting from the combining 120 of a PDA 117 with the first suspension 115. Panel A of FIG. 2 illustrates the agglomeration of starting Si NPs 103 into secondary particles 205 surrounded by the PDA 117, resulting in the forming of a first composition 200, a composite material of Si NPs 103 and PDA 117, positioned within the second suspension 125. Panel B of FIG. 2 illustrates how the first composition 200 is combined with binder 127 in a third combining 130 step, resulting in the forming of a second composition 210, a composite structure that includes a binder 127 coating the Si NP/PDA composite material. Finally, Panel C of FIG. 2 illustrates a third composition 220 resulting from the combination of drying 150 and removing 160 of the PDA from the second composition 210. As illustrated in Panel C, a third composition 220, positioned on the final electrode 165, may be essentially free of PDA 117 and be constructed of essentially binder-coated secondary particles 205 (e.g., aggregates of Si NPs and/or aggregates of aggregates).

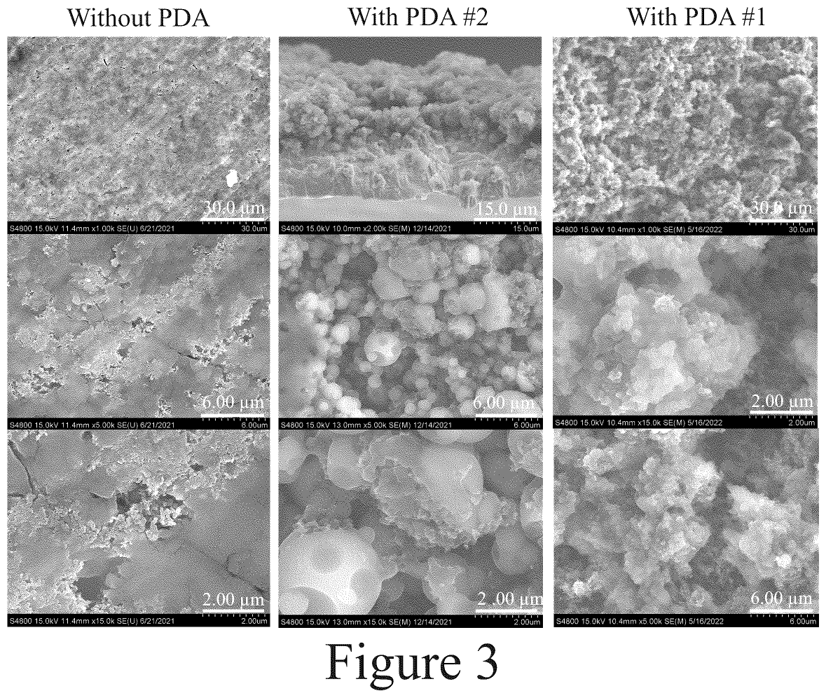

The SEM images illustrated in FIG. 3 show a clear difference in the structure of the electrode when a polyacrylic acid is used as a PDA, with carbon nanotubes as the carbon source and polyimide as the binder. In this example, the starting silicon nanoparticles were 6 nm in diameter and had a molecular surface functionalization of polyethylene oxide. The solids content in the slurry was 20%. For both electrodes, the final composition of the electrode was 80 wt % Silicon, 10 wt % carbon nanotubes, and 10 wt % polyimide binder. The SEM images in FIG. 3 without a PDA contained the same components in the same concentration. Where the non-PDA electrode structure is mostly compact without the PDA (Left), when the PDA is added large secondary particles are created that range in size. In addition, depending on the chemical identity of the PDA, the structure of the electrode can be controlled to have homogeneous secondary particles consisting of well-defined spheres (Middle), or heterogeneous secondary particles with smaller feature dimensions (Right). The addition of the PDA resulted in electrodes with higher porosity, larger pore sizes, and large secondary aggregates. The total electrode density decreased from >2 g/cm³ (without PDA) to <1 g/cm³ (with PDA) with the addition of the PDA with a corresponding change in porosity from 10 vol % (without PDA) to 60 vol % (with PDA).

The degree of aggregation into secondary particles, the size of the secondary particles, and the overall electrode morphology can be controlled by changing the mass ratio of active material primary particles to the PDA in the slurry. FIG. 4 shows SEM images of an electrode that has been structured with a polyacrylic acid is used as a PDA This electrode contains carbon nanotubes as the carbon source and polyimide as the binder. The starting silicon nanoparticles were 6 nm in diameter and had a molecular surface functionalization of polyethylene oxide. The solids content in the slurry was 20 wt %. For both electrode sets, the final composition of the electrode was 80 wt % silicon, 10 wt % carbon nanotubes, and 10 wt % polyimide binder. In FIG. 4, the ratio between the silicon and the PDA was changed such that the total solids loading within the slurry was kept constant at 20 wt %. In each instance the electrodes were treated in an identical fashion. For an electrode without PDA and a series of PDA concentrations, refer to FIG. 3. From these images, the size of the secondary particle decreases as the ratio of active material-to-PDA increases. Moreover, the texture of the electrode changes as the ratio of the PDA changes; lower PDA concentrations appear to increase the electrode roughness. The total electrode density decreased from >1.4 g/cm³ (without PDA) to 0.8 g/cm³ (with PDA) with an increase of the PDA concentration relative to the silicon. The range of visible size pores was between 50 nm and 1 μm for the highest silicon to PDA ratio to between 100 nm and 5 μm for the lowest Si to PDA ratio. Similarly, the range of secondary particle sizes decreased from between 200 nm and 2 μm for the highest silicon to PDA ratio to between 100 nm and 500 nm for the lowest Si to PDA ratio.

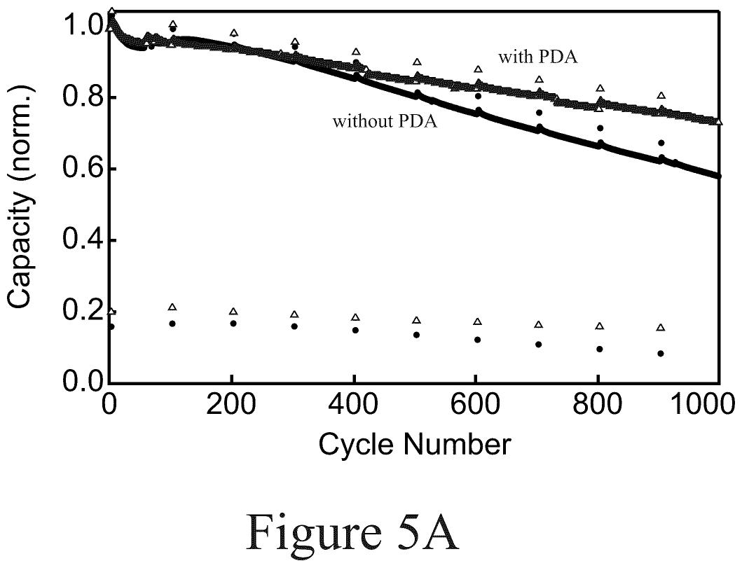

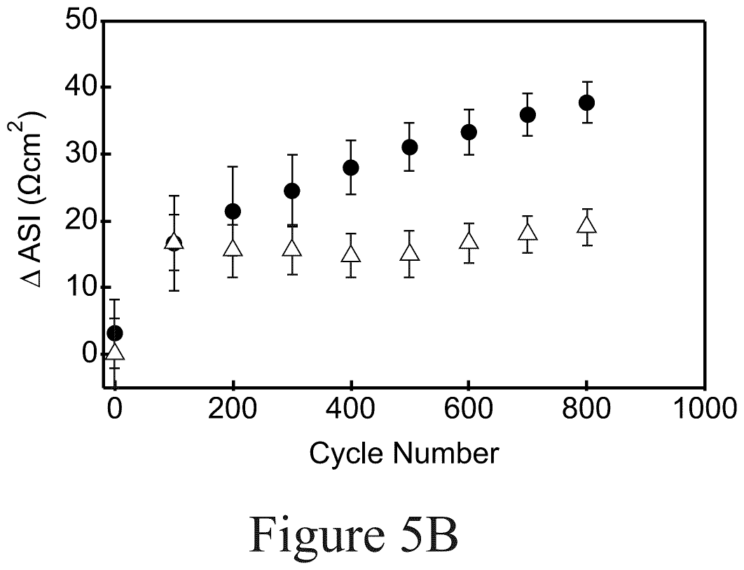

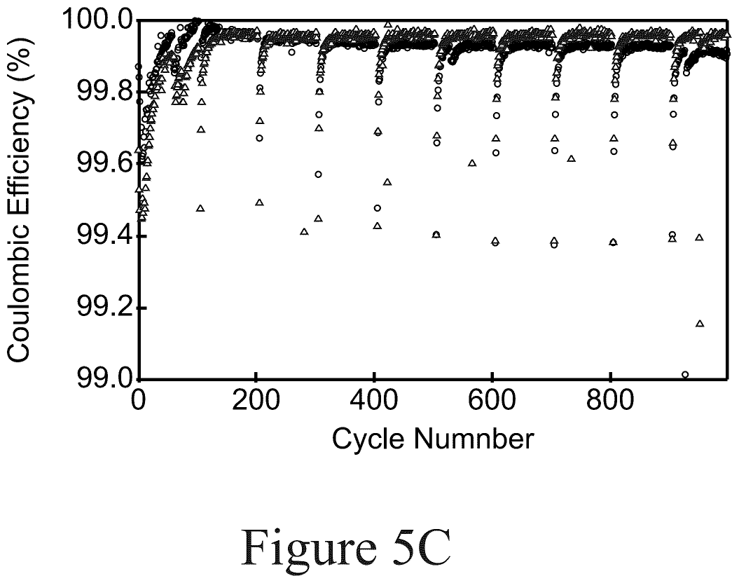

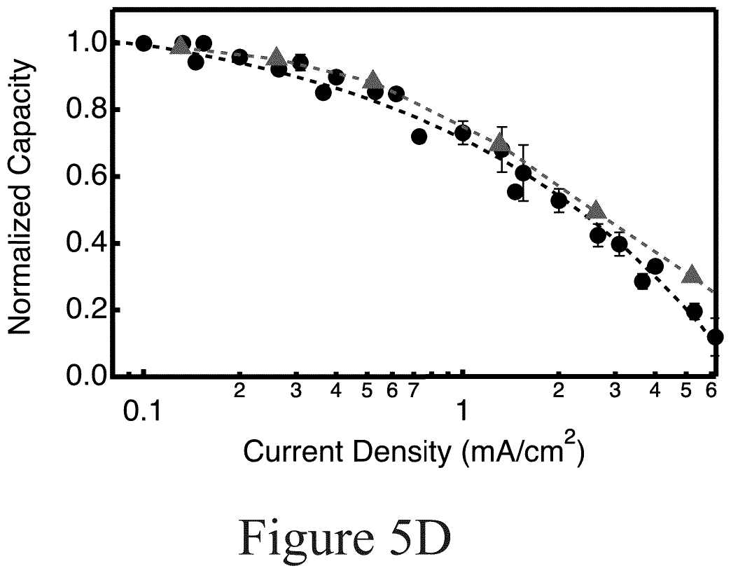

The electrochemical performance of electrodes that were made with PDAs are compared against electrodes that were prepared without a PDA. The cycle data shown FIG. 5A reveals that the capacity retention of the PDA electrode is significantly higher than non-PDA electrodes. This is also clear from the improved coulombic efficiency which particularly apparent at cycle numbers >400 in FIG. 5B. Impedance rise in the PDA electrodes is nearly completely mitigated as the cycle number increases, where the non-PDA electrodes display a consistent gain with increasing cycles (see FIG. 5C). Finally, the rate capability of the PDA electrodes illustrated in FIG. 5D is slightly improved compared to the non-PDA electrodes. These results were obtained using polyacrylic acid as the PDA. The starting silicon nanoparticles were 6 nm in diameter and had a molecular surface functionalization of polyethylene oxide. The solids content in the slurry was 20 wt %. In each instance the electrodes were treated in an identical fashion. For both electrode sets, the final composition of the electrode was 80 wt % Silicon, 10 wt % carbon nanotubes, and 10 wt % polyimide binder. These measurements were performed in a coin cell format with lithium nickel manganese cobalt oxide (NMC811) as the cathode.

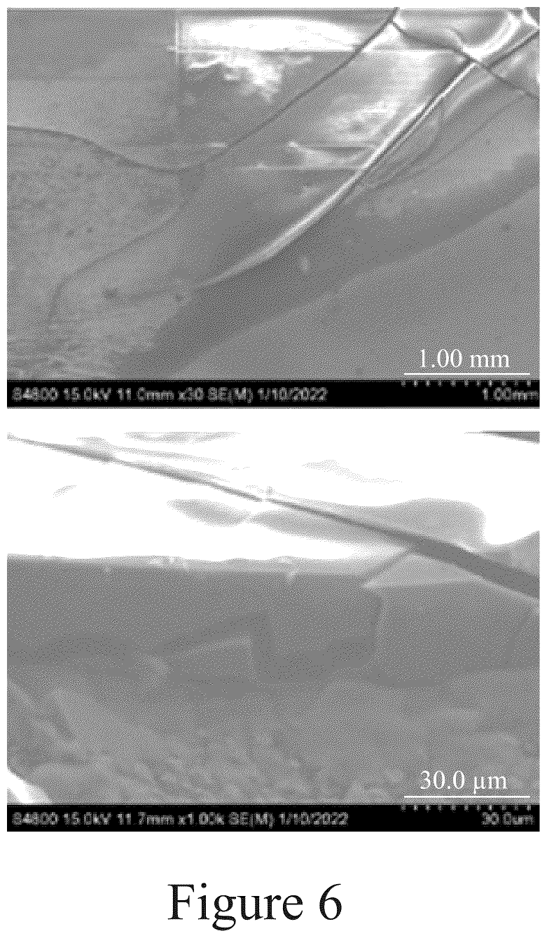

In some embodiments of the present disclosure, in place of or in addition to the agglomerate-inducing PDAs described above, one can impart a high degree of homogeneity to the electrode such that only one pore size exists across the entire electrode and the density of the electrode is maximized at >2 g/cm³. Here, the PDA was compatible with the silicon nanoparticles, their surface functionalization, and the binder. SEM images of an electrode made with a PDA that does not induce agglomeration, such as polyethylene glycol, is shown in FIG. 6. In this example, the starting silicon nanoparticles were 6 nm in diameter and had a molecular surface functionalization of polyethylene oxide. The particles were dispersed in N-methyl pyrrolidone. A 20 wt % solution of polyethylene glycol was added to the solution follow the addition of carbon nanotubes that were suspended in N-methyl pyrrolidone making a slurry solution. Finally, a solution of polyimide dissolved in NMP was added to the slurry solution. The solids content in the slurry was 20 wt %. The final composition of the electrode was 80 wt % Silicon, 10 wt % carbon nanotubes, and 10 wt % polyimide binder. The polyethylene glycol was removed during a heating treatment after drying the electrode. This process is identical to that described above. The morphology of this electrode is nearly completely featureless. The electrode shows a monolithic structure with no discernable secondary structures like the ones shown in FIG. 6 demonstrating that we can control the entire spectrum of electrode microporosity (completely flat to highly structured). This morphology was achieved by matching the chemical identity of the PDA to the identity of the molecular surface functionalization of the nanoparticles. In some instances where high volumetric capacity is desired, densely packed and well dispersed electrodes are an ideal morphology.

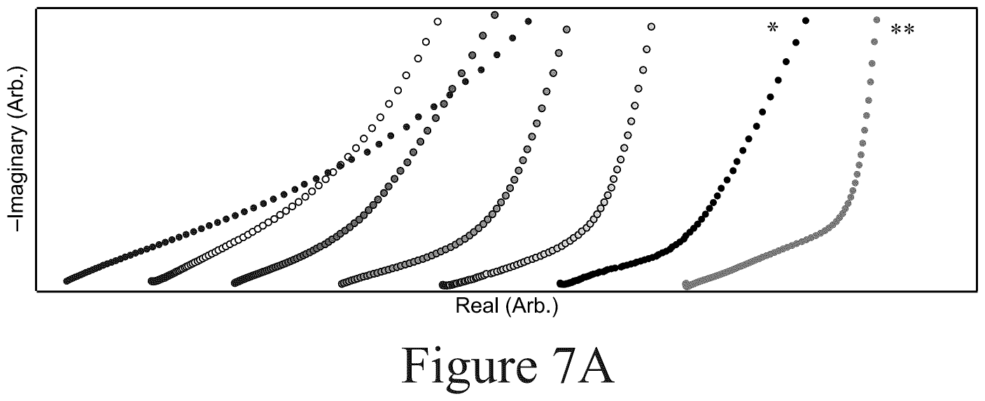

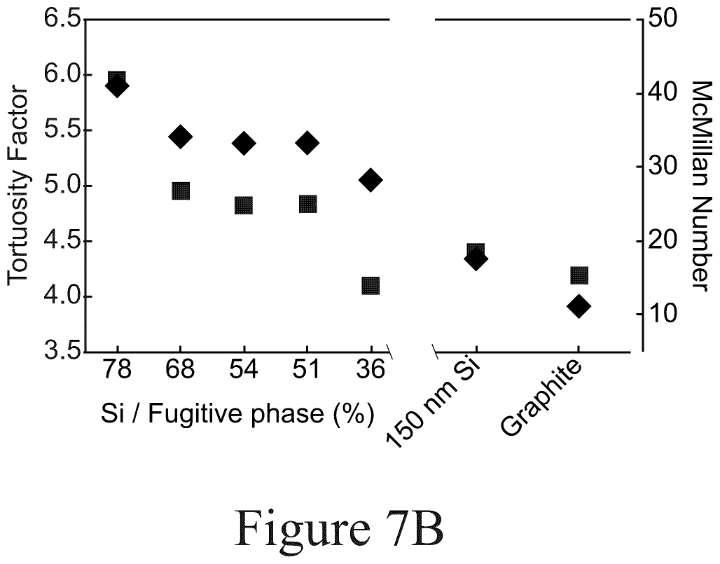

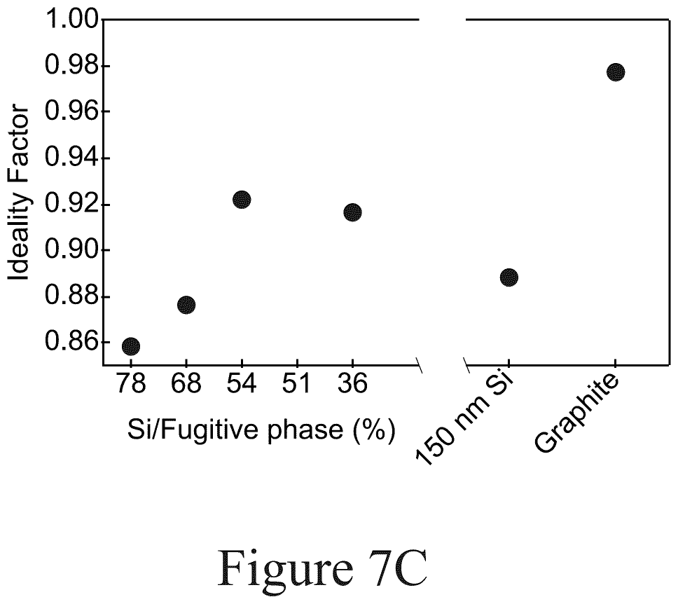

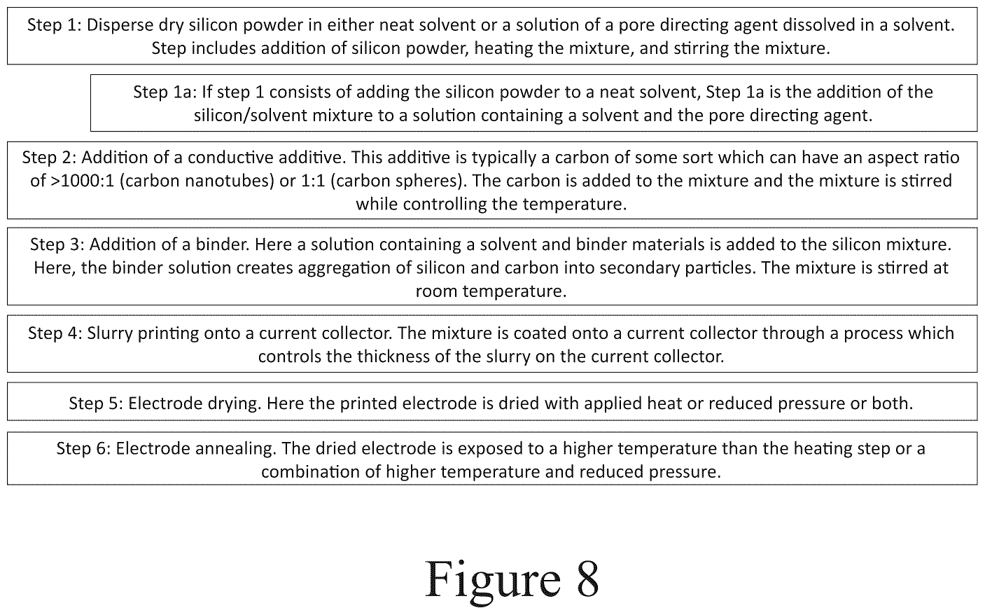

The benefit of the compatible PDAs can be seen from measuring the ionic transport properties of the electrodes. To delineate compatible PDAs from those that induce mesoporosity, we label the compatible PDA as the fugitive phase. FIG. 7A illustrates electrochemical impedance data (Nyquist plots) of 5 different silicon-based electrodes that were fabricated with varied PDA/Si ratios under ion-blocking conditions such that the resultant impedance spectrum is represented with a Transmission line model. Also shown are Nyquist plots for both large silicon (25× larger than the silicon in the colored traces) and a graphite electrode as comparison electrodes. Clearly, the shape of the Nyquist plot changes with increasing fugitive phase concentration where the line evolves from a nearly completely straight to a clear ‘hockey stick’ shape indicating an improvement in the homogeneity and particle dispersion. Results from fitting analysis show a slight decrease in the tortuosity factor and Macmullin number with increasing fugitive phase: Si ratio where the highest ratio of the fugitive phase to silicon is 2.7 and the lowest is 1.2 such that the tortuosity factor of the highest fugitive phase: Si electrode is 4.0, is similar to the graphite and large silicon particle controls. More importantly, the data illustrated in FIG. 7C show that the ideality factor—a measure of the homogeneity of the electrode—increases with increasing fugitive phase: Si. This data confirm that not only can one affect the morphology of the electrode on a micro scale, but on a nanoscale as well.

In some embodiments of the present disclosure, in place of or in addition to the agglomerate-inducing PDAs described above, the concentration of the solids in the slurry suspension can affect the porosity. SEM images in FIG. 9 show how the secondary particle size, shape, and distribution along the electrode can be controlled by the total solids content of the slurry. Here the solids content can vary from 1% to 20%. The size of the secondary particles decreases from large particles that are >100 μm and a sparsely distributed on the copper current collector by voids >100 μm to secondary particles with sizes ˜10 μm that are densely packed together and have void spaces in the range of 100 μm to 100 nm. Variation of the electrode morphology at this level can provide control of the mechanical stress and strain experienced by the electrode during lithiation and dilithiation. This morphology is also useful for controlling mass transport within the electrode as well as the total silicon interface that is accessible to the electrolyte.

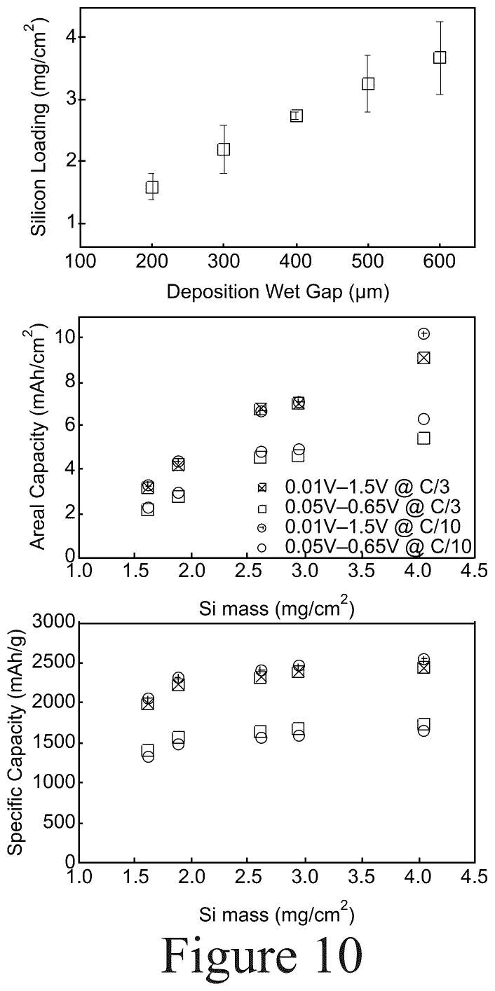

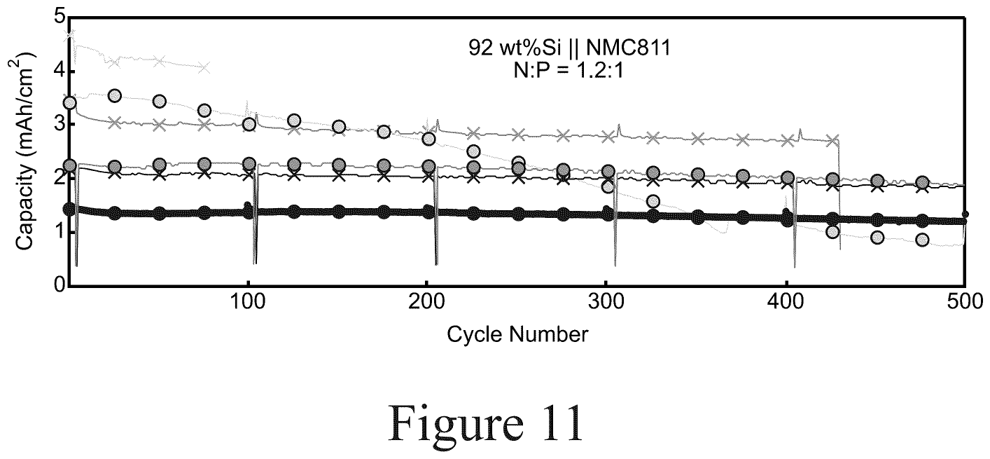

In some embodiments of the present disclosure, the thickness of the electrode will be modulated to control the total electrode capacity. FIG. 10 shows the effect of increasing the thickness of the slurry that is deposited onto the current collect, know and the wet gap. Here, the resulting silicon mass loading follows a linear relationship with an increasing wet gap from 100 μm to 600 μm resulting in silicon loadings between 1.7 mg/cm² and 3.8 mg/cm². The solids content in the slurry was 20%. The final composition of the electrode was 92 wt % Silicon, 4 wt % carbon nanotubes, and 6 wt % polyimide binder. The fine control over the silicon loading is an essential aspect of energy density maximization and cell balancing for long cycle and calendar life batteries. The capacity of these electrodes follows a linear relationship with the loading, where the areal capacity ranges from 3.8 mAh/cm² to 10 mAh/cm² when cycled between 0.01V and 1.5V vs Li in a half cell. The gravimetric capacity of the electrodes with varied thickness displays a nearly flat capacity between 2000 and 2500 mAh/g_{electrode} (where g_{electrode} is the mass of the silicon, carbon, and binder). When cycled in a lower voltage window, 0.05V to 0.65V, the electrodes deliver between 2.1 and 5.9 mAh/cm². The gravimetric capacity is between 1400 and 1600 mAh/g_{electrode}. These data indicate that the silicon utilization is high (nearly 100%) and is not affected by the thickness of the electrode. The cycle rate capability of these electrodes is shown in FIG. 10. When cycled at C/3, the electrodes deliver >98% of the capacity compared to the slower C/10 cycle rate.

In some embodiments of the present disclosure, the thickness of the electrode may be used to create a battery with different thicknesses so as to increase the energy density of the battery. FIG. 10 compares the cycle life of batteries for silicon electrodes that did not contain a PDA (red, circles) against those that did (blue, crosses). In this example, the batteries with a higher capacity are more susceptible to cell failure for the non-PDA containing electrodes. By contrast, the electrodes that were made with a PDA display a long cycle life that is reasonably independent of thickness. This is an essential result of as is shows the direct impact of engineering the morphology of the electrode with PDAs improves the battery performance.

### Experimental:

In a first example, silicon nanoparticles of spherical geometry with a size between 2 nm and 20 nm with a molecular coating of allyloxy polyethylene oxide were suspended in N-methyl pyrrolidone (NMP) (solvent 105) in a first combining 110 step. To this suspension, a solution of a pore-directing agent, 10 wt % polyacrylic acid in N-methyl pyrrolidone, and a conductive carbon source was added in the second combining step 117. This suspension was thoroughly mixed by stirring at a temperature of 100C. To this suspension, a polymer was added to the to act as an electrode binder was added (polyimide) combining step. This suspension was thoroughly mixed using a planetary mixer and coated onto a copper current collector. The electrode was dried under vacuum at 120° C. for four hours. The dried electrodes were then transferred to a furnace. In the furnace, the electrodes were heated to 550° C. under flowing nitrogen gas for four hours. The final composition of the electrode is 80 wt % silicon, 10 wt % polyimide, 10 wt % C45 (no detectable amounts of PDA remained).

In a second example, silicon nanoparticles of a generally spherical shape, with an average diameter of 6 nm, and with a surface coating of diethylene oxide methyl ether (PEO) were used to make electrodes using the same method and conditions described for the first example. The final electrode mass was about 92 wt % Si NPs. This method is applicable to materials other than silicon, for example graphite or other Li alloy materials like aluminum, tin, indium, or other variants of silicon such as boron alloyed silicon. This method can be applied to other shapes of nanomaterials as well such as nano rods, fibers, cubes, or porous active materials. This method is also applicable to different sized nanoparticles, for example Si NPs having particle sizes between 2 nm and 150 nm. This method is also applicable to active materials (e.g., Si NPs) with different surface coatings. For example, silicon with a graphitic or non-graphitic carbon coating, and/or silicon with an oxide coating, and/or silicon with an alloy coating.

Binders. The binder used to make the exemplary electrodes described herein was a polyimide polymer. It made up about 10% of the total mass of the electrode. In principle, any material, whether polymeric or not, can act as an electrode binder. The key is that the binder is resistant to the removal step 160 of the PDA. For example, if heat is used to remove the PDA, the binder must be able to tolerate heat up to whatever temperature is needed to remove the PDA. Or if the PDA is washed away by a solvent, the binder must be insoluble in the PDA removal solvent.

Electrically Conductive Additives. An electrically conductive additive was used to improve the electrical conductivity of the composite anode. In some embodiments of the present disclosure, the additive used was ‘carbon black’, a spherically shaped, amorphous carbon with sizes in the tens of nm. Another form of carbon that can be used is single walled or multi-walled carbon nanotubes. In some embodiments of the present disclosure, single walled CNTs were used. Carbon of other morphologies can be used as well. For example, carbon nanorods with aspect ratios between 1:1 and 1000:1. Other electrically conductive additives can also be used. Such as metals like copper.

Pore Directing Agents. Three different PDAs were tested to make electrodes: 450 k molecular weight polyacrylic acid, PDA #1, polypropylene carbonate PDA #2, and polyethylene glycol (PDA #3, see FIGS. 6 and 7A-7C). Other examples of PDAs include polyvinylpyrrolidone, polystyrene, polyester, poly(methyl methacrylate), poly(phtalaldehyde), polyamide, and/or polyurethane. Any polymer that is soluble in the slurry solvent that can be removed by a post processing step can be used as the PDA. The key to the functionality of the PDA is in its molecular interactions with the active material such that it dictates the dispersion of the primary particles in the slurry. In some embodiments of the present disclosure, soluble salts such as NaCl may be used as PDAs. These salts do not induce aggregation but can nevertheless create void volume in the final electrode.

Slurry Properties. In some embodiments of the present disclosure, a solvent that can be used to make suspensions includes N-methyl pyrrolidone and/or water.

Electrode Characteristics. Electrodes are a composite mixture (i.e., composition) of active material (silicon nanoparticles), conductive additive (carbon black), binder (polyimide), and porosity directing agent (PAA or PEG). The ratio of the electrodes from FIG. 3 and the electrochemical performance data are 40% Si, 5% binder, 5% carbon, and 40% porosity. These ratios can vary greatly depending. FIG. 4 illustrates variation of the PDA content. Composite electrodes were blade coated onto a copper current collector from a slurry. The thickness of the wet print ranged between 100 μm and 600 μM. Coating thickness controls the capacity of the entire electrode and can range greatly depending on the desired electrode capacity. Once dried, the electrodes thickness was between 10 μm and 150 μm. The porosity of these electrodes ranged from 15% to 70%. The size of the pores ranged from 3 nm to single μm. An electrode may have more than one pore size. For example, small particles can pack together with 3 nm pores into larger aggregates, and the larger aggregates may have pore sizes on the order of 1 μm.

The Applicant produced 5.9 nm diameter intrinsic silicon (i: Si) nanoparticles (NPs) at the tens of grams scale for silicon nanoparticles with a molecular surface functionalization of allyloxy (diethylene oxide)methyl ether ‘Si@PEO’ electrodes. Numerous multi-day growth runs to produce ˜50 g of 5.9 nm i: Si NPs were completed. ˜43 g of this supply was used to demonstrate the scaling methodology will translate to large scale (i.e., hundreds of g to kg). ˜1 L of the allyloxy (diethylene oxide)methyl ether (PEO) molecular precursor was purified by distilling over calcium hydride under inert gas. To this was added the as-grown, 43-g i: Si@SiHₓ powder to ˜500 mL of this precursor, heated to reflux (˜200° C.) for 3 days, then cooled the crude Si@PEO mixture to ambient temperature and stored in lab air ambient. The crude Si@PEO mixture was purified in lab air ambient through solvent-antisolvent washing procedures as detailed in our recent publication on this material. The process worked well and generated 63 g of solid Si@PEO NPs that appears as a dark blue-black solid reminiscent of bulk Si boule before mechanical agitation that converts it into a brown powder. This behavior is due to optical effects and has been observed for many Si@PEO NP samples at small scale and validates the molecular coating process kinetically stabilizes the Si NPs to air oxidation.

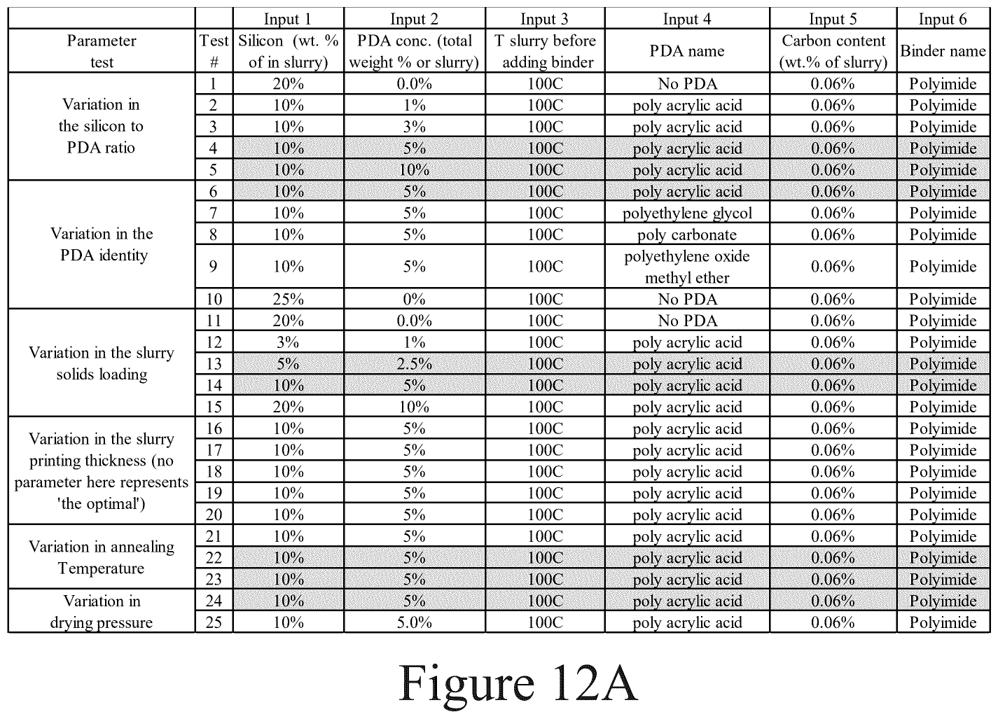

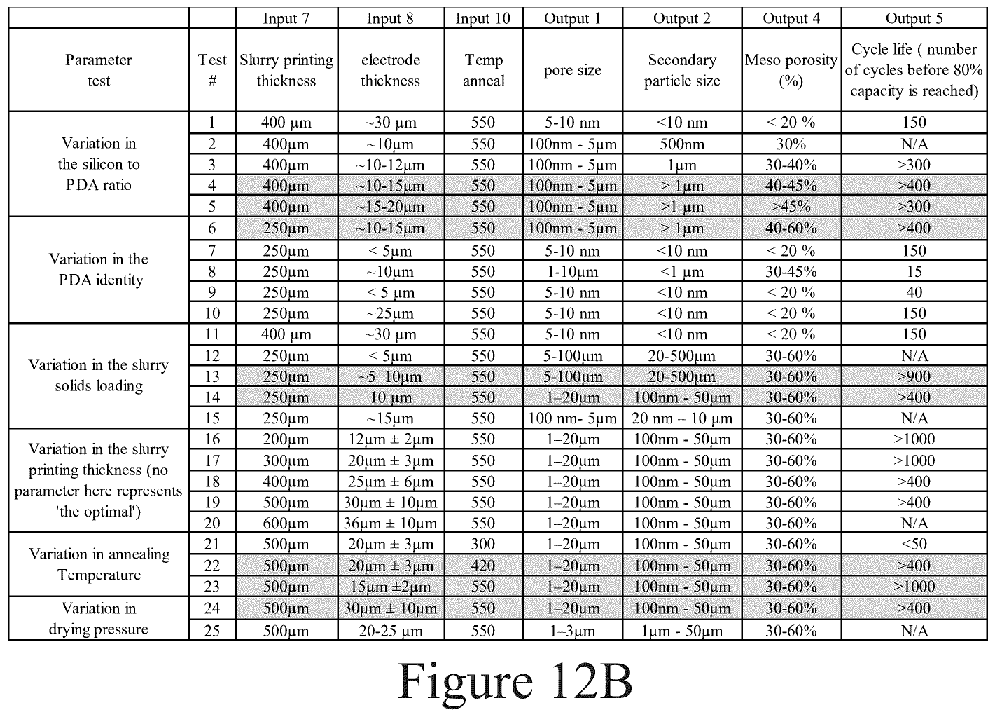

FIGS. 12A and 12B summarize PDA experiments and results reported herein. Shaded rows indicated champion devices having superior final physical properties and/or performance metrics. Input #9, not shown in FIGS. 12A or 12B was “drying conditions” and is summarized in Table 1. Output #3, not shown in FIGS. 12A or 12B was “pore shape” and is summarized in Table 2.

TABLE 1
Drying Conditions

| Test | |
|---|---|
| # | Conditions |
| 1 | 15° C./min ramp |
| | rate to 150° C. for |
| | 4 hours at 1 torr |
| 2 | 15° C./min ramp |
| | rate to 150° C. for |
| | 4 hours at 1 torr |
| 3 | 15° C./min ramp |
| | rate to 150° C. for |
| | 4 hours at 1 torr |
| 4 | 15° C./min ramp |
| | rate to 150° C. for |
| | 4 hours at 1 torr |
| 5 | 15° C./min ramp |
| | rate to 150° C. for |
| | 4 hours at 1 torr |
| 6 | 15° C./min ramp |
| | rate to 150° C. for |
| | 4 hours at 1 torr |
| 7 | 15° C./min ramp |
| | rate to 150° C. for |
| | 4 hours at 1 torr |
| 8 | 15° C./min ramp |
| | rate to 150° C. for |
| | 4 hours at 1 torr |
| 9 | 15° C./min ramp |
| | rate to 150° C. for |
| | 4 hours at 1 torr |
| 10 | 15° C./min ramp |
| | rate to 150° C. for |
| | 4 hours at 1 torr |
| 11 | 15° C./min ramp |
| | rate to 150° C. for |
| | 4 hours at 1 torr |
| 12 | 15° C./min ramp |
| | rate to 150° C. for |
| | 4 hours at 1 torr |
| 13 | 15° C./min ramp |
| | rate to 150° C. for |
| | 4 hours at 1 torr |
| 14 | 15° C./min ramp |
| | rate to 150° C. for |
| | 4 hours at 1 torr |
| 15 | 15° C./min ramp |
| | rate to 150° C. for |
| | 4 hours at 1 torr |
| 16 | 15° C./min ramp |
| | rate to 150° C. for |
| | 4 hours at 1 torr |
| 17 | 15° C./min ramp |
| | rate to 150° C. for |
| | 4 hours at 1 torr |
| 18 | 15° C./min ramp |
| | rate to 150° C. for |
| | 4 hours at 1 torr |
| 19 | 15° C./min ramp |
| | rate to 150° C. for |
| | 4 hours at 1 torr |
| 20 | 15° C./min ramp |
| | rate to 150° C. for |
| | 4 hours at 1 torr |
| 21 | 15° C./min ramp |
| | rate to 150° C. for |
| | 4 hours at 1 torr |
| 22 | 15° C./min ramp |
| | rate to 150° C. for |
| | 4 hours at 1 torr |
| 23 | 15° C./min ramp |
| | rate to 150° C. for |
| | 4 hours at 1 torr |
| 24 | 15° C./min ramp |
| | rate to 150° C. for |
| | 4 hours at 1 torr |
| 25 | 15° C./min ramp |
| | rate to 150° C. for |
| | 4 hours at 760 torr |

TABLE 2
Pore Shapes

| Test | |
|---|---|
| # | Conditions |
| 1 | Densely packed |
| | electrode |
| | with planar |
| | “brink-like” |
| | structure. |
| | Mud cracks |
| 2 | column like |
| | voids |
| | some spherical |
| | shapes |
| 3 | column like |
| | voids |
| | some spherical |
| | shapes |
| 4 | column like |
| | voids |
| 5 | column like |
| | voids |
| 6 | column like |
| | voids |
| 7 | Densely packed |
| | electrode |
| | with planar |
| | “brink-like” |
| | structure |
| 8 | Network of |
| | small voids |
| 9 | Densley packed |
| | electrode |
| | with planar |
| | “brink-like” |
| | structure |
| 10 | Densley packed |
| | electrode |
| | with planar |
| | “brink-like” |
| | structure. |
| | Mud cracks |
| 11 | Densely packed |
| | electrode |
| | with planar |
| | “brink-like” |
| | structure. |
| | Mud cracks |
| 12 | Sparsely packed |
| | large silicon |
| | aggregate |
| | particles with |
| | large |
| | space between |
| | aggregates |
| 13 | Sparsely packed |
| | large silicon |
| | aggregate |
| | particles with |
| | large |
| | space between |
| | aggregates |
| 14 | Intermediate |
| | packed |
| | silicon |
| | aggregate |
| | particles |
| | with space |
| | between |
| | aggregates |
| 15 | Densely packed |
| | silicon |
| | aggregate |
| | particles with |
| | small |
| | network of |
| | pores between |
| 16 | Densely packed |
| | silicon |
| | aggregate |
| | particles with |
| | small |
| | network of |
| | pores between |
| 17 | Densely packed |
| | silicon |
| | aggregate |
| | particles with |
| | small |
| | network of |
| | pores between |
| 18 | Densely packed |
| | silicon |
| | aggregate |
| | particles with |
| | small |
| | network of |
| | pores between |
| 19 | Densely packed |
| | silicon |
| | aggregate |
| | particles with |
| | small |
| | network of |
| | pores between |
| 20 | Densely packed |
| | silicon |
| | aggregate |
| | particles with |
| | small |
| | network of |
| | pores between |
| 21 | Densely packed |
| | silicon |
| | aggregate |
| | particles with |
| | small |
| | network of |
| | pores between |
| 22 | Densely packed |
| | silicon aggregate |
| | particles with |
| | small |
| | network of pores |
| | between |
| 23 | Densely packed |
| | silicon aggregate |
| | particles with |
| | small |
| | network of pores |
| | between |
| 24 | Densely packed |
| | silicon aggregate |
| | particles with |
| | small |
| | network of non- |
| | uniform pores |
| | between |
| 25 | Densely packed |
| | silicon aggregates |
| | well defined pore |
| | sizes and shapes |

### Examples

Example 1. A composition comprising: a plurality of silicon nanoparticles; and a binder, wherein: the composition has a porosity between 10 vol % and 90 vol % or between 30 vol % and 80 vol %.

Example 2. The composition of Example 1, wherein the plurality of silicon nanoparticles have an average diameter between 1 nm and 50 nm or between 1 nm and 10 nm.

Example 3. The composition of either Example 1 or Example 2, wherein at least a portion of the plurality of silicon nanoparticles are agglomerated to form a plurality of secondary particles.

Example 4. The composition of any one of Examples 1-3, wherein the plurality of secondary particles have an average diameter between 1 nm and 500 μm or between 20 μm and 500 μm or between 100 nm and 50 μm.

Example 5. The composition of any one of Examples 1-1, wherein the binder comprises a polymer.

Example 6. The composition of any one of Examples 1-5, wherein the polymer comprises at least one of a polyimide, polyimide, a polyamide-imide, a polyether ether ketone, polytetrafluoroethylene, a polyetherimide, polybenzimidazole, polyphthalamide, or a combination thereof.

Example 7. The composition of any one of Examples 1-1, wherein the silicon nanoparticles are present at a concentration between 1 wt % and 99 wt % or between 10 wt % and 99 wt % or between 50 wt % and 99 wt %.

Example 8. The composition of any one of Examples 1-1, wherein the binder is present at a concentration between 1 wt % and 99 wt % or between 1 wt % and 50 wt % or between 1 wt % and 25 wt %.

Example 9. The composition of any one of Examples 1-1, further comprising a conductive additive.

Example 10. The composition of any one of Examples 1-9, wherein the conductive additive comprises at least one of carbon black or a carbon nanotube.

Example 11. The composition of any one of Examples 1-10, wherein the carbon nanotubes have an aspect ratio between 1:1 and 1000:1.

Example 12. The composition of any one of Examples 1-1, further comprising a plurality of pores having a pore size distribution between 1 nm and 10 μm or between 5 nm and 100 μm or between 1 μm and 20 μm or between 100 nm and 5 μm.

Example 13. The composition of any one of Examples 1-12, wherein the plurality of pores are characterized by at least one of column-like voids, voids between secondary particles, a network of non-uniform pores, or a combination thereof.

Example 14. The composition of any one of Examples 1-1, further comprising a mesoporosity between greater than 0 vol % and 60 vol % or between 30 vol % and 60 vol % or between 40 vol % and 60 vol %.

Example 15. An electrode comprising any one of the compositions of Examples 1-14, positioned on a current collector.

Example 16. The electrode of Example 15, comprising a cycle life between 300 cycles and 1000 cycles before a capacity of 80% is achieved.

Example 17. The electrode of either Example 15 or Example 16, wherein the composition is present on the current collector in the form of a layer having a thickness between 5 μm and 50 μm or between 10 μm and 25 μm.

Example 18. A method of making a composition or device of any one of Examples 1-12, the method comprising the use of a pore-directing agent (PDA) to produce at least a portion of the porosity present in the composition.

Example 19. The method of Example 18, wherein the PDA comprises a polymer.

Example 20. The method of either Example 18 or Example 19, wherein the polymer comprises at least one of polyacrylic acid, polyethylene, polypropylene, polyvinylpyrrolidone, polypropylene carbonate, polyethylene glycol, or a combination thereof.

Example 21. The method of any one of Examples 18-20, comprising one or more of following steps, any two or more of which may be combined in a single step: a first combining of Si NPs and a solvent to make a first suspension; a second combining of the first suspension with a PDA; a third combining of the second suspension with a binder to form a third suspension; depositing of the third suspension onto a current collector to make a first intermediate electrode; drying the first electrode to make a second intermediate electrode; and removing of at least a portion of the PDA to create an electrode having a composition of any one of Examples 1-11.

Example 22. The method of any one of Examples 18-21, wherein the PDA is added to the first suspension at a weight percent between greater than 0 wt % and less than 100 wt % or between 3 wt % and 30 wt % or between 2 wt % and 10 wt %, relative to the first suspension.

Example 23. The method of any one of Examples 18-22, wherein the Si NPs are added to the first suspension at a weight percent between greater than 0 wt % and less than 50 wt % or between 3 wt % and 25 wt % or between 5 wt % and 10 wt %, relative to the first suspension.

Example 24. The method of any one of Examples 28-23, wherein the drying is performed at a temperature between 30° C. and 250° C.

Example 25. The method of any one of Examples 28-24, wherein the removing is performed at a temperature between 100° C. and 1000° C.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A composition comprising:
a plurality of silicon nanoparticles; and
a binder, wherein:
the composition has a porosity between 10 vol % and 90 vol %.

2. The composition of claim 1, wherein the plurality of silicon nanoparticles have an average diameter between 1 nm and 50 nm.

3. The composition of claim 1, wherein at least a portion of the plurality of silicon nanoparticles are agglomerated to form a plurality of secondary particles.

4. The composition of claim 3, wherein the plurality of secondary particles have an average diameter between greater than 1 nm and 500 μm.

5. The composition of claim 1, wherein the binder comprises a polymer.

6. The composition of claim 5, wherein the polymer comprises at least one of a polyimide, polyimide, a polyamide-imide, a polyether ether ketone, polytetrafluoroethylene, a polyetherimide, polybenzimidazole, polyphthalamide, or a combination thereof.

7. The composition of claim 1, wherein the silicon nanoparticles are present at a concentration between 1 wt % and 99 wt %.

8. The composition of claim 1, wherein the binder is present at a concentration between 1 wt % and 99 wt %.

9. The composition of claim 1, further comprising a conductive additive.

10. The composition of claim 9, wherein the conductive additive comprises at least one of carbon black, a carbon nanotube, or a combination thereof.

11. The composition of claim 10, wherein the carbon nanotubes have an aspect ratio between 1:1 and 1000:1.

12. The composition of claim 1, further comprising a plurality of pores having a pore size distribution between 1 nm and 10 μm.

13. The composition of claim 12, wherein the plurality of pores are characterized by at least one of column-like voids, voids between secondary particles, a network of non-uniform pores, or a combination thereof.

14. The composition of claim 1, further comprising a mesoporosity between greater than 0 vol % and 60 vol %.

15. An electrode comprising any one of the composition of claim 1, positioned on a current collector.

16. The electrode of claim 15, comprising a cycle life between 300 cycles and 1000 cycles before a capacity of 80% is achieved.

17. The electrode of claim 15, wherein the composition is present on the current collector in the form of a layer having a thickness between 5 μm and 50 μm or between 10 μm and 25 μm.

18. A method of making a composition, the method comprising the use of a pore-directing agent (PDA) to produce at least a portion of the porosity present in the composition.

19. The method of claim 18, wherein the PDA comprises a polymer.

20. The method of claim 19, comprising one or more of following steps, any two or more of which may be combined in a single step:
a first combining of Si NPs and a solvent to make a first suspension;
a second combining of the first suspension with a PDA;
a third combining of the second suspension with a binder to form a third suspension;
depositing of the third suspension onto a current collector to make a first intermediate electrode;
drying the first electrode to make a second intermediate electrode; and
removing of at least a portion of the PDA to create an electrode having the composition positioned on the electrode.
